(19) United States
(12) Patent Application Publication
(10) Pub. No.: US 2008/0299533 A1
(43) Pub. Date: Dec. 4, 2008

(54) Naughty or nice meter

(75) Inventor: Frank C. Orsini, Hoboken, NJ (US)

Correspondence Address: FRANK C. ORSINI, 103 4th St. Apt. #2, Hoboken, NJ, 07030, US

(73) Assignee: Frank C. Orsini, Hoboken, NJ (US)

(21) Appl. No.: 11/806,850

(22) Filed: Jun. 4, 2007

(51) Int. Cl. G09B 3/00

(52) U.S. Cl. 434/353; 434/322; 434/362

(57) ABSTRACT

The “Naughty or Nice Meter” is a visual novelty toy designed to let Children know where they stand on a “Naughty or Nice Meter”. Originally conceived for Christmas, the “Naughty or Nice Meter” has widespread applications and can be used for other seasons of the year or events. The device has twelve (12) behavioral questions children will be graded on. The grading system for each question is a point scale from zero thru five. Zero (0) being the worst (Naughty) score and five (5) being the best (Nice) score. A calculator is used to add/subtract the total number of points accumulated for all twelve (12) questions. The meter is categorized in five number ranges (0-35; 36-41; 42-47; 48-53; 54-60). Each range signifies a different percentage grade of naughty to nice. The “Meter” lights up/down to the numbered range displayed according to the total number accumulated by the calculator.

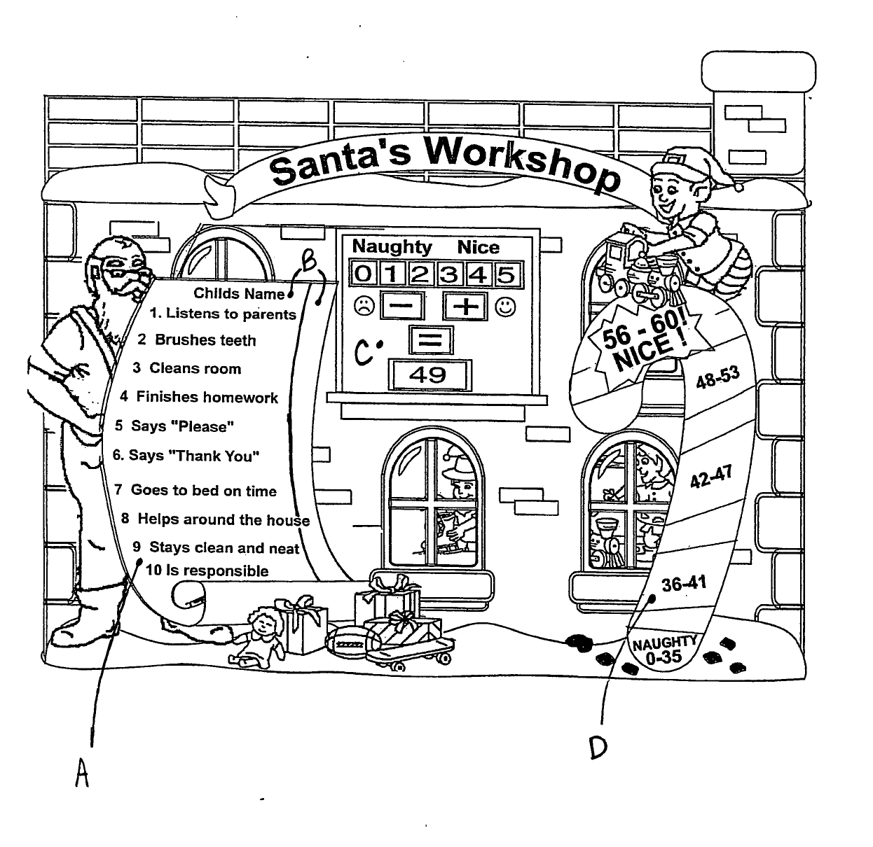

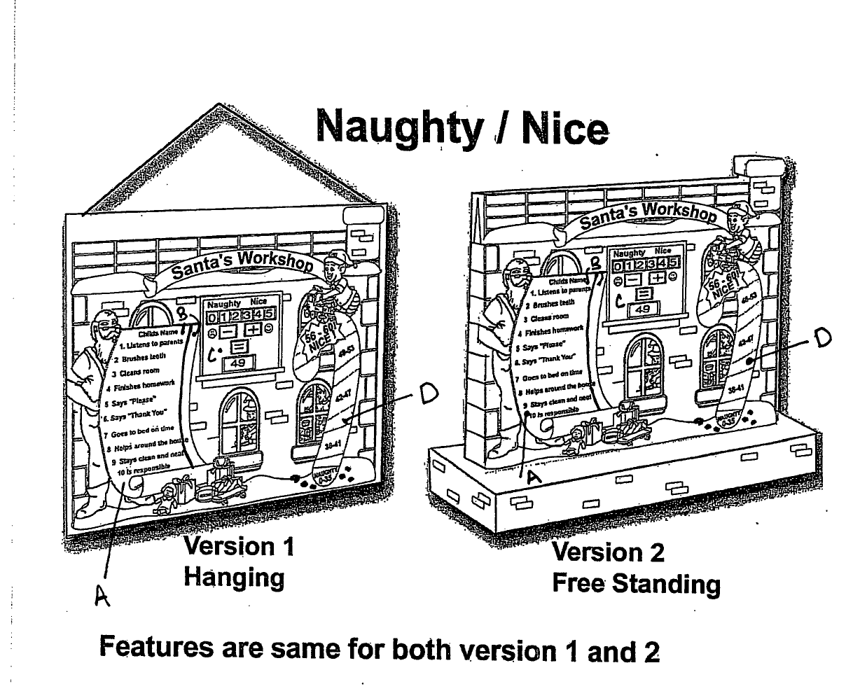

### BRIEF SUMMARY OF THE INVENTION

Undoubtedly, the abstract and background show the uniqueness of the product of this invention. The “Naughty or Nice Meter”, although initiated from the Christmas Holiday season, is a product that allows a visual representation of being “Naughty or Nice”. The product honors and exemplifies the time-honored traditional saying as to whether you have been “Naughty or Nice”. It also transcends the original Christmas Holiday Season to all Holiday seasons and perhaps even birthdays or even a day-to-day “Naughty or Nice Meter.” It could not be said enough that the “Naughty or Nice Meter” is a visual product designed to calibrate if you have been “Naughty or Nice”. No other product exists.

### BACKGROUND OF THE INVENTION

This invention is originally derived from the Holiday Season of Christmas and the theme of being “Naughty or Nice”. Although primarily associated with Christmas, the theme/phrase is said almost as much as “Happy Holiday”, “Merry Christmas” or even “Happy Birthday” during a conversational exchange with a child. These phrases are equally said: “Have you been good this year?”; is “Santa going to give you coal?”; “Your birthday is coming up, have you been good?”; “You'll find no presents for you this year, you have been naughty; and/or “birthday present? Have you been a good boy/girl?” Of course, there are other phrases, but the theme is the same: “Have you been naughty or nice?” The “Naughty or Nice Meter” is an original idea incorporating the phrase into a visual product. Aside from “Christmas Coal” (solely for being “naughty”) seen during the Christmas Holiday season, there is no product in the market place designed to grade whether a person is “Naughty or Nice”. And there is no visual product designed for other seasons of the year and/or birthdays as well. Aside from the original novelty aspect of the product, parents/guardians can use the product to help guide basic behaviors.

The “Naughty or Nice Meter” has a “list” of 12 questions and a space where a parent/guardian can write the persons name on top (water color writing surface); a space at the end of each question where the parent/guardian can grade the child; a calculator is used for adding/subtracting the total grade for all questions, along with a display of the total number accumulated. There is also a “meter” categorized in number percent range from “Naughty” at the bottom of the meter to “Nice” at the top.

The twelve questions on the list can either be written by the child's parent/guardian (tailored to each individual child) or supplied. Examples of questions are as follows:
1. Listens to Parents.
2. Tells the Truth.
3. Says “Please” and “Thank You”.
4. Eats all meals.
5. Has a Clean Room.
6. Helps around the house.
7. Completes homework on time.
8. Does well in school.
9. Follows Directions
10. Plays nice with other children.
11. Respects others.
12. Goes to bed on time.

The grading scale is zero through five for each question. Zero is the worst score and five is the best score. Best score is sixty (twelve questions “times” five). The grading scale ranges from Naughty to Nice is:

| | | |
|---|---|---|
| 54-60 pts = | NICE! | 90%-100% |
| 48-53 pts = | a little more . . . | 80%-89% |
| 42-47 pts = | ½ way there!!! | 70%-79% |
| 36-41 pts = | Needs to improve | 60%-69% |
| 00-35 pts = | NAUGHTY | 00%-59% |

As a Christmas “Naughty or Nice Meter”, Santa has the “list” of 12 questions. As a Holiday, Birthday or day-to-day “Naughty or Nice Meter”, the Christmas figure of Santa can be replaced with a figure or scene appropriate with the occasion.

### BRIEF DESCRIPTION OF THE SEVERAL VIEWS OF THE DRAWING

In the submitted drawing (Which represents a Christmas Holiday Scene):
1. A=The List of 12 questions.
2. B=The area where the person's name is written and the area where the number grade is given for the question.
3. C=The calculator for adding/subtracting total number grade.
4. D=The “Meter” which has the number range from Zero (0) to Sixty (60) with the ability to light up according to the number represented on the calculator.

### DETAILED DESCRIPTION OF THE INVENTION

The “Naughty or Nice Meter” is a product used to grade (and reward) children to be on there best behavior. It uses a background scene, a list of questions, water color marker space to write child's name and to grade a child on each question, a calculator to add/subtract total number score accumulated, a screen to display the total number as given from the calculator and a meter calibrated into percent ranges to determine if you are naughty or nice. The meter will light up or down to the number range according to the total number shown on the screen. In the submitted application, Santa (character can change depending on season of year/holiday/event) is holding the “Naughty or Nice” list with a space for a person's name on top. Below the name is the list of questions. The questions are numbered one thru twelve (1-12). To the right of each question is a space to grade the person who is on the list. The grade is a number Zero (0) thru Five (5). Ideally, name and grade are written with an easy erasable water marker.

In the submitted application, a calculator is used to add (subtract when a grade is lowered) each score. The numbers are totaled and entered to receive a total score that is displayed on an screen. In the submitted application, the “Meter” is in the form of a Candy Cane (again, the “Meter” can also be any decoration/item/character depending on season of year/holiday/event). The “meter” will be marked with a percent range of numbers from zero thru sixty (zero being the least amounts of points and sixty the maximum (12 questions times a score of five) for grading.

The Naughty or Nice “Meter”, in this case a Candy Cane, lights up to the range displayed that coincides with the number displayed on the screen, which represents the total graded number achieved by adding all twelve (12) number point grades for each question.

The “meter”, in the submitted application, has an Elf—happy on top—depicting “Nice”; a crying Elf with coal on the bottom—depicting “Naughty”. The numbers indicate if you are Naughty or Nice. The higher the number, the nicer you are. The lights on the Meter illuminate the percent number range you are in. All the while Santa is analyzing the list.

As children improve or falter, parents can adjust the grade by marking the new grade next to the question and then using the calculator to adjust the total grade, which will adjust, if need be, the light range on the meter.

I, Frank Orsini, claim:

1. A “Naughty or Nice Meter” grading product comprising of 12 behavioral questions, a calculator and a “Meter” numbered in a range from Zero (0) to Sixty (60).

2. A “Naughty or Nice Meter” grading product as stated in claim #1, which has a space to write a name, space to put the list of questions and also has a space to write a grade next to the question.

3. A “Naughty or Nice Meter” grading product as stated in claim #1, which has a calculator to add/subtract and display the number on a screen.

4. A “Naughty or Nice Meter” grading product as stated in claim #1, which has an illuminating ornamental object that lights up to the appropriate number range that correlates with the number represented as the total number displayed on the screen by the calculator.
